(19) United States
(12) Patent Application Publication
(10) Pub. No.: US 2007/0047467 A1
(43) Pub. Date: Mar. 1, 2007

(54) Optimal path selection system

(75) Inventors: Tohru Enoki, Fukuoka (JP); Kenichi Ishii, Fukuoka (JP); Yuji Ito, Fukuoka (JP); Yoshiaki Horinouchi, Fukuoka (JP); Shinichi Hayashi, Fukuoka (JP); Shinichi Kuranari, Fukuoka (JP)

Correspondence Address: KATTEN MUCHIN ROSENMAN LLP, 575 MADISON AVENUE, NEW YORK, NY, 10022-2585, US

(73) Assignee: FUJITSU LIMITED

(21) Appl. No.: 11/349,607

(22) Filed: Feb. 8, 2006

(30) Foreign Application Priority Data
Aug. 30, 2005 (JP) 2005-249832

(51) Int. Cl. H04L 12/28

(52) U.S. Cl. 370/254

(57) ABSTRACT

A router includes a label-mapping-message receiving unit, a passing-node managing unit, and a passing-node selecting unit. The label-mapping-message receiving unit receives a label-mapping message including label information and PV TLV information from all adjacent nodes. The passing-node managing unit registers received label information and PV TLV information to manage the information. When a line fault occurs in a network, the passing-node selecting unit selects PV TLV information that does not include an identifier of the router itself from among registered PV TLV information. Thus, an optimal path is determined based on selected PV TLV information so that a loop does not occur in the network.

### CROSS-REFERENCE TO RELATED APPLICATIONS

This application is based upon and claims the benefit of priority from the prior Japanese Patent Application No. 2005-249832, filed on Aug. 30, 2005, the entire contents of which are incorporated herein by reference.

### BACKGROUND OF THE INVENTION

1. Field of the Invention

The present invention relates to a technology for switching paths to an optimal path in a multi-protocol-label-switching (MPLS) router.

2. Description of the Related Art

Carrier services using MPLS have become popular recently. Typical signaling protocols of the MPLS include a resource reservation protocol (RSVP) and a label distribution protocol (LDP). Generally, a service using the RSVP statically sets a path, and the work load tends to be increased. Since a service using the LDP has an advantage of being able to automatically set a path according to dynamic routing information, the LDP is often used.

The popularization of the Internet is rapidly increasing the network scale and the flow rate of packets, so that occurrence of a fault in a line requires a prompt establishment of an adequate alternative path. A general establishment of an alternative path upon conventional occurrence of a line fault takes place as follows. At a stage prior to the occurrence of a line fault, every node switches paths between adjacent nodes and performs path computation to determine a priority path. A label switched path (LSP) for the priority path is then set, and a label advertisement message is transmitted. Those processes take place at every node.

When occurrence of a line fault is detected, an alternative path is determined through path switching between adjacent nodes and path computation. An LSP for a priority path is deleted, and a message to cancel the assigned label is transmitted. A new LSP for an alternative path newly determined is set, and a new label advertisement message is transmitted.

The following conventional technique is known as a bypass route switching system. In a packet switching network including plural nodes each having a correlation table of predetermined destinations and packet transmission paths, and means for performing routing by determining a next packet transmission path from destination information of a received packet and the correlation table, each node includes means for detecting that a fault disables relaying from a node, means for collecting node information on a set of all sender nodes for a route having the node as a pass point to a destination, and the node, means for collecting node information on nodes that are adjacent to a node belonging to the set and that do not belong to the set of the nodes and whose route to the destination is normal, and means for selecting one node from the adjacent nodes, and setting a new group of nodes to the destination from those nodes that belong to the set in such a way as to pass through the selected node (Japanese Patent Application Laid-Open No. H5-292125).

The following conventional technique is known as a distribution message transmission suppressing system in a network. In a network having plural path selecting apparatus groups connected to one another, an existing internet protocol (IP) gateway protocol open shortest path first (OSPF) is installed in each path selecting apparatus group in the network, connection information of all the paths in the network is shared by all the path selecting apparatus groups, each path selecting apparatus group additionally includes a traffic report function of reporting traffic information in an adjacent path selecting apparatus, and upon reception of a “undeliverable destination” message (internet control message protocol ((ICMP) message) from an adjacent path selecting apparatus that has detected occurrence of a fault in a specific route, the adjacent path selecting apparatus switches a routing-destination adjacent path selecting apparatus and updates a database in a link status corresponding to a network load to suppress IP packets to be transmitted according to the traffic information of the currently adjacent path selecting apparatus (Japanese Patent Application Laid-Open No. 2002-9820).

In the conventional technology, however, in general establishment of an alternative path, a loop state occurs among routers to an adequate alternative path in a transient state until the adequate alternative path is established. This brings about a problem of increasing the network load and causing a packet loss. As the scale of the network increases, path computation, message exchanges, and deletion and re-registration of an LSP upon occurrence of a line fault takes time, which can cause a traffic disconnection over a long period of time (approximately several seconds to several tens of seconds) due to the network loop or the like.

The above bypass route switching system and the above distribution message transmission suppressing system have similar problems. Furthermore, the bypass route switching system is directed to a packet switching network that employs a fixed routing system, therefore, it is not applicable to a network that employs a dynamic routing system, such as the OSPF.

### SUMMARY OF THE INVENTION

It is an object of the present invention to at least solve the above problems in the conventional technology.

A system according to one aspect of the present invention is for selecting an optimal path in a network using a plurality of routers that perform data transfer based on a label affixed to a packet. The system includes a router. The router includes a receiving unit configured to receive a label-mapping message that includes information on a path, from at least one adjacent router; a registering unit configured to register the information; and a selecting unit configured to select, from among paths included in registered information, a path that does not include the router, to select an optimal path. The optimal path is a path that does not cause a loop.

The other objects, features, and advantages of the present invention are specifically set forth in or will become apparent from the following detailed description of the invention when read in conjunction with the accompanying drawings.

### BRIEF DESCRIPTION OF THE DRAWINGS

FIG. 1 is a schematic of a router according to a first embodiment of the present invention;

FIG. 2 depicts a flow of data when an optimal path is set according to the first embodiment;

FIG. 3 depicts a sequence when an optimal path is set according to the first embodiment;

FIG. 4 depicts a flow of data when an alternative path is set according to the first embodiment;

FIG. 5 depicts a sequence when an alternative path is set according to the first embodiment;

FIG. 6 is a schematic of a router according to a second embodiment of the present invention;

FIG. 7 depicts a flow of data when an alternative path is set according to the second embodiment;

FIG. 8 depicts a sequence when an alternative path is set according to the second embodiment;

FIG. 9 is a schematic of a router according to a third embodiment of the present invention;

FIG. 10 depicts a sequence when an optimal path is set according to the third embodiment;

FIG. 11 depicts a flow of data when an alternative path is set according to the third embodiment;

FIG. 12 depicts a sequence when an alternative path is set according to the third embodiment;

FIG. 13 is a schematic of a router according to a fourth embodiment of the present invention;

FIG. 14 depicts a sequence when an optimal path is set according to the fourth embodiment;

FIG. 15 depicts a flow of data when an alternative path is set according to the fourth embodiment;

FIG. 16 depicts a sequence when an alternative path is set according to the fourth embodiment;

FIG. 17 depicts a data format of specific type length value (TLV) information;

FIG. 18 is a schematic of a router according to a fifth embodiment of the present invention;

FIG. 19 depicts a flow of data when an alternative path is set according to the fifth embodiment;

FIG. 20 depicts a sequence when an alternative path is set according to the fifth embodiment;

FIG. 21 depicts a modification of a router; and

FIG. 22 depicts another modification of a router.

### DETAILED DESCRIPTION OF THE PREFERRED EMBODIMENTS

Exemplary embodiments according to the present invention are explained below in detail with reference to the accompanying drawings.

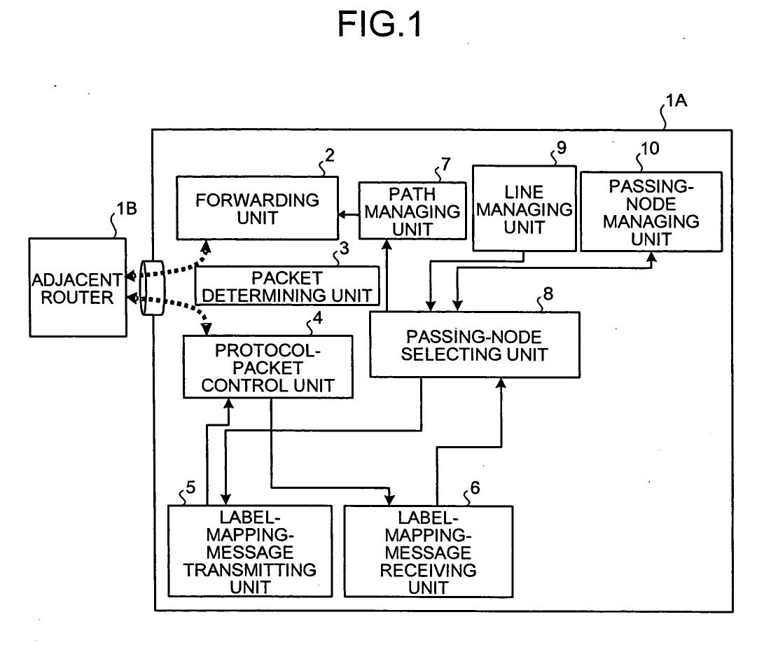

FIG. 1 is a schematic of a router that realizes an optimal path selection system according to a first embodiment of the present invention. As shown in FIG. 1, a router 1A as a node includes a forwarding unit 2, a packet determining unit 3, a protocol-packet control unit 4, a label-mapping-message transmitting unit 5, a label-mapping-message receiving unit 6, a path managing unit 7, a passing-node selecting unit 8, a line managing unit 9, and a passing-node managing unit 10.

The packet determining unit 3 distributes those of packets received from a router 1B of an adjacent node (adjacent router) that are addressed to the node to the protocol-packet control unit 4, and distributes packets not addressed to the node or packets that should be relayed to the forwarding unit 2. The forwarding unit 2 retransmits the packets from the packet determining unit 3 that are not addressed to the node to another adjacent router 1C. The forwarding unit 2 sets a table for packet relay in response to a request from the path managing unit 7.

The protocol-packet control unit 4 transmits LDP packets addressed to the node, received from the packet determining unit 3, to the label-mapping-message receiving unit 6. The protocol-packet control unit 4 transmits a transmission message received from the label-mapping-message transmitting unit 5 to the adjacent router 1B.

The path managing unit 7 determines an optimal path from various paths obtained through learning based on a routing protocol, such as the OSPF or routing information protocol (RIP), according to the priority of the protocol and a condition of, for example, whether the path is close or distant, and registers the optimal path in the forwarding unit 2 as routing information needed for relaying. The path managing unit 7 receives a request for setting a packet relay table received from the passing-node selecting unit 8 or the like, and requests the forwarding unit 2 to set the packet relay table.

The label-mapping-message transmitting unit 5 affixes an identifier of the node to path-vector (PV) TLV information of a label-mapping message, and transmits the label-mapping message to the adjacent router 1B. The label-mapping-message receiving unit 6 receives the label-mapping message from the adjacent router 1B, extracts label information and the PV TLV information from the label-mapping message, and notifies the passing-node selecting unit 8 of those pieces of information.

The passing-node selecting unit 8 notifies the passing-node managing unit 10 of the label information and the PV TLV information notified by the label-mapping-message receiving unit 6. The passing-node selecting unit 8 requests the passing-node managing unit 10 to search for an alternative path in response to notification from the line managing unit 9. According to the alternative path notified by the passing-node managing unit 10 as the result of the search, the passing-node selecting unit 8 causes the path managing unit 7 to set the alternative path.

The passing-node managing unit 10 manages the label information and the PV TLV information notified by the passing-node selecting unit 8 in a time-sequential manner or in the order of notification. In response to the request for an alternative path search from the passing-node selecting unit 8, the passing-node managing unit 10 searches for an optimal path, and notifies a search request source of the search result. The line managing unit 9 detects link-up or link-down of a line, and notifies the passing-node selecting unit 8 of the detection result.

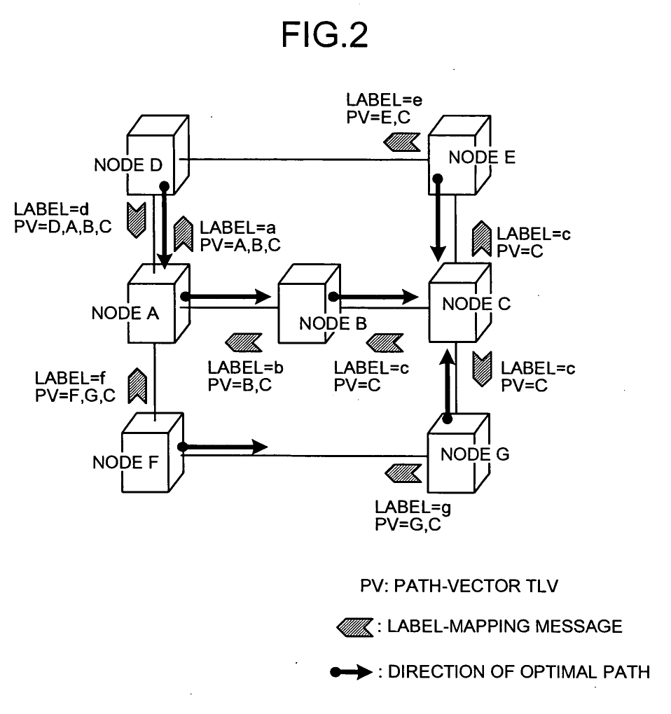

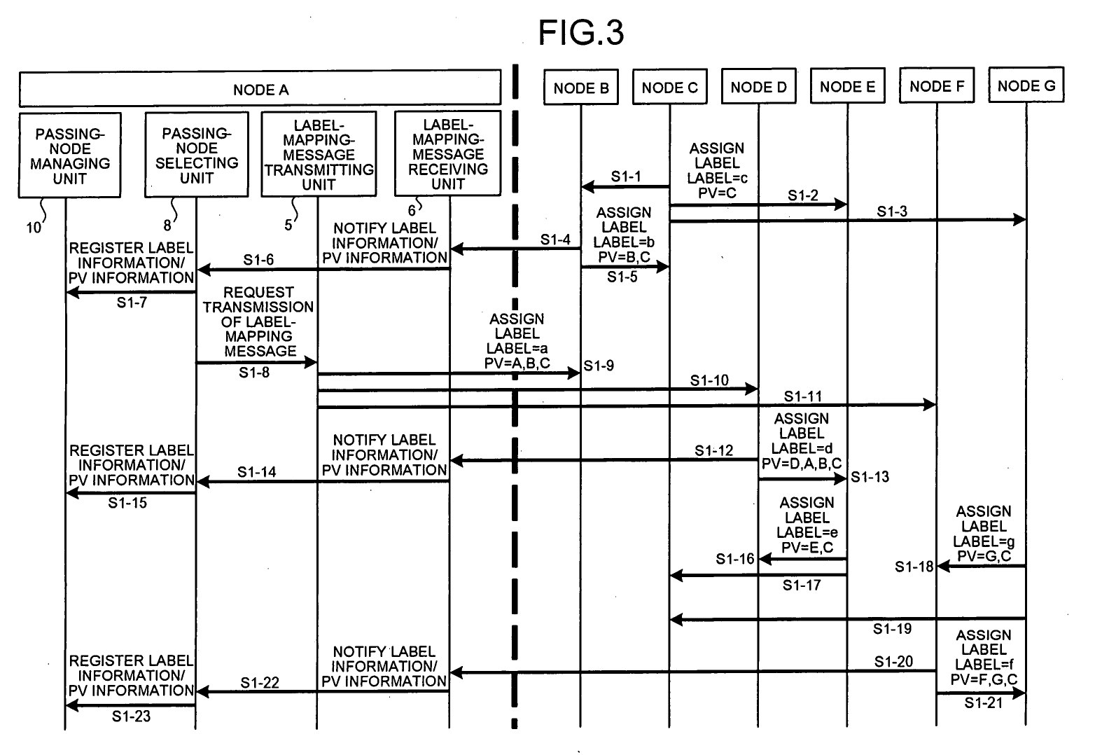

A sequence of setting an optimal path in an IP network in a normal state, i.e., before occurrence of a line fault is explained with reference to FIGS. 2 and 3. FIG. 2 depicts a flow of data, and FIG. 3 depicts the sequence. As shown in FIG. 2, there are, for example, seven nodes A to G that constitute the IP network. The node A is connected to the node B, the node D, and the node F. The node B is connected to the node C in addition to the node A. The node C is connected to the nodes E and G in addition to the node B. The node E is connected to the node D in addition to the node C. The node G is connected to the node F in addition to the node C.

It is assumed that as the direction of the optimal path, the node A is directed toward the node B, the node B is directed toward the node C, the nodes E and G are both directed toward the node C, the node D is directed toward the node A, and the node F is directed toward the node G. With such a node connecting relationship and the direction of the optimal path, attention is paid to traffic from the node A to the node C. A priority path in this case is from the node A to the node C through the node B. Each of the seven nodes A to G includes the router 1A shown in FIG. 1.

The label-mapping-message transmitting unit 5 sets a router identifier “C” of the node to the PV TLV information. The label-mapping-message transmitting unit 5 then transmits a label-mapping message containing label information “c” of the node and PV TLV information “C” to all adjacent nodes, namely the node B, the node E, and the node G (steps S1-1, S1-2, and S1-3).

The label-mapping-message receiving unit 6 of the node B receives the label-mapping message transmitted from the node C, and notifies the label information “c” and the PV TLV information “C” in the label-mapping message to the passing-node selecting unit 8 of the node B. The passing-node selecting unit 8 of the node B registers the label information “c” and the PV TLV information “C”, notified by the label-mapping-message receiving unit 6, in the passing-node managing unit 10 of the node B.

The passing-node selecting unit 8 of the node B requests the label-mapping-message transmitting unit 5 of the node B to transmit the label-mapping message. Upon reception of the transmission request for the label-mapping message, the label-mapping-message transmitting unit 5 of the node B adds a router identifier “B” of the node to the PV TLV information “C” received from the node C, and transmits a label-mapping message containing label information “b” of the node and PV TLV information “B, C” to all adjacent nodes, namely the node A, and the node C (steps S1-4, and S1-5).

The label-mapping-message receiving unit 6 of the node A receives the label-mapping message transmitted from the node B, and notifies the label information “b” and the PV TLV information “B, C” in the label-mapping message to the passing-node selecting unit 8 of the node A (step S1-6). The passing-node selecting unit 8 of the node A registers the label information “b” and the PV TLV information “B, C”, notified by the label-mapping-message receiving unit 6, in the passing-node managing unit 10 of the node A (step S1-7). At this time, the status of the information from the node B being “used” is registered, together with the label information “b” and the PV TLV information “B, C”, in the passing-node managing unit 10 of the node A, as shown in Table 1.

TABLE 1

| | Label-mapping | | |
|---|---|---|---|
| | message transmission | Label | Path-vector TLV |
| Status | source | information | information |
| Used | Node B | b | B, C |

The passing-node selecting unit 8 of the node A requests the label-mapping-message transmitting unit 5 of the node A to transmit the label-mapping message (step S1-8). Upon reception of the transmission request for the label-mapping message, the label-mapping-message transmitting unit 5 of the node A adds a router identifier “A” of the node A to the PV TLV information “B, C” received from the node B, and transmits a label-mapping message containing label information “a” of the node and PV TLV information “A, B, C” to all adjacent nodes, namely the node B, the node D, and the node F (steps S1-9, S1-10, and S1-11).

The node D that has received the label-mapping message from the node A registers the received label information “a” and PV TLV information “A, B, C” in the passing-node managing unit 10 of the node D through an operation similar to the operation for the node A. The node D adds its router identifier “D” to the received PV TLV information “A, B, C”, and transmits a label-mapping message containing label information “d” of the node and PV TLV information “D, A, B, C” to all adjacent nodes, namely the node A, and the node E (steps S1-12, and S1-13).

The node A that has received the label-mapping message from the node D registers the received label information “d” and PV TLV information “D, A, B, C” in the passing-node managing unit 10 of the node A through an operation similar to the operation done to receive the label-mapping message from the node B (steps S1-14, and S1-15). The label information “d”, the PV TLV information “D, A, B, C”, and the status of the information from the node D being “unused” are added to the information registered in the passing-node managing unit 10 of the node A at step S1-7, as shown in Table 2.

TABLE 2

| | Label-mapping | | |
|---|---|---|---|
| | message | Label | Path-vector TLV |
| Status | transmission source | information | information |
| Used | Node B | b | B, C |
| Unused | Node D | c | D, A, B, C |

The node E receives the label-mapping message transmitted from the node C at step S1-2, and registers the received label information “c” and PV TLV information “C” in the passing-node managing unit 10 of the node E through an operation similar to the operation done for the node A. The node E adds its router identifier “E” to the received PV TLV information “C”, and transmits a label-mapping message containing label information “e” of the node and PV TLV information “E, C” to all adjacent nodes, namely the node D, and the node C (steps S1-16, and S1-17).

Likewise, the node G that has received the label-mapping message transmitted from the node C at step S1-3 registers the received label information “c” and PV TLV information “C” in the passing-node managing unit 10 of the node G. The node G adds its router identifier “G” to the received PV TLV information “C”, and transmits a label-mapping message containing label information “g” of the node and PV TLV information “G, C” to all adjacent nodes, namely the node F, and the node C (steps S1-18, and S1-19).

The node F receives the label-mapping message transmitted from the node G, and registers the received label information “g” and PV TLV information “G, C” in the passing-node managing unit 10 of the node F through an operation similar to the operation done for the node A. The node F adds its router identifier “F” to the received PV TLV information “G, C”, and transmits a label-mapping message containing label information “f” of the node and PV TLV information “F, G, C” to all adjacent nodes, namely the node A, and the node G (steps S1-20, and S1-21).

The node A that has received the label-mapping message from the node F registers the received label information “f” and PV TLV information “F, G, C” in the passing-node managing unit 10 of the node A through an operation similar to the operation done to receive the label-mapping message from the node B (steps S1-22, and S1-23). The label information “f”, the PV TLV information “F, G, C”, and the status of the information from the node F being “unused” are added to the information registered in the passing-node managing unit 10 of the node A at steps S1-7 and S1-15, as shown in Table 3. The order from step S1-1 to step S1-23 should not necessarily be restrictive to the one mentioned above, but may be changed as needed according to, for example, the times needed for processes at the individual nodes.

TABLE 3

| | Label-mapping | | |
|---|---|---|---|
| | message | Label | Path-vector TLV |
| Status | transmission source | information | information |
| Used | Node B | b | B, C |
| Unused | Node D | d | D, A, B, C |
| Unused | Node F | f | F, G, C |

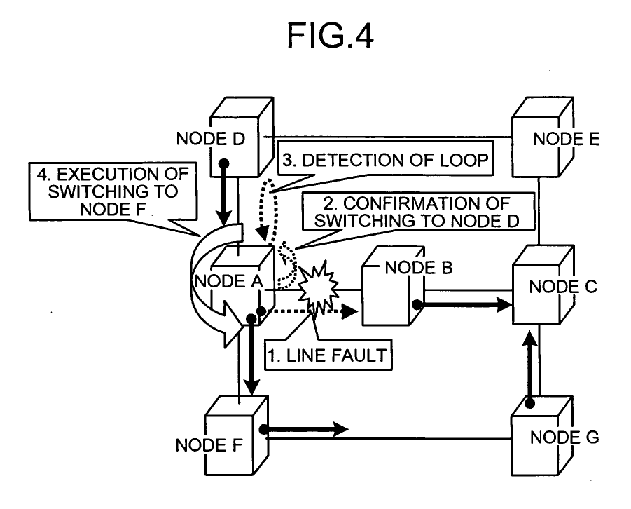

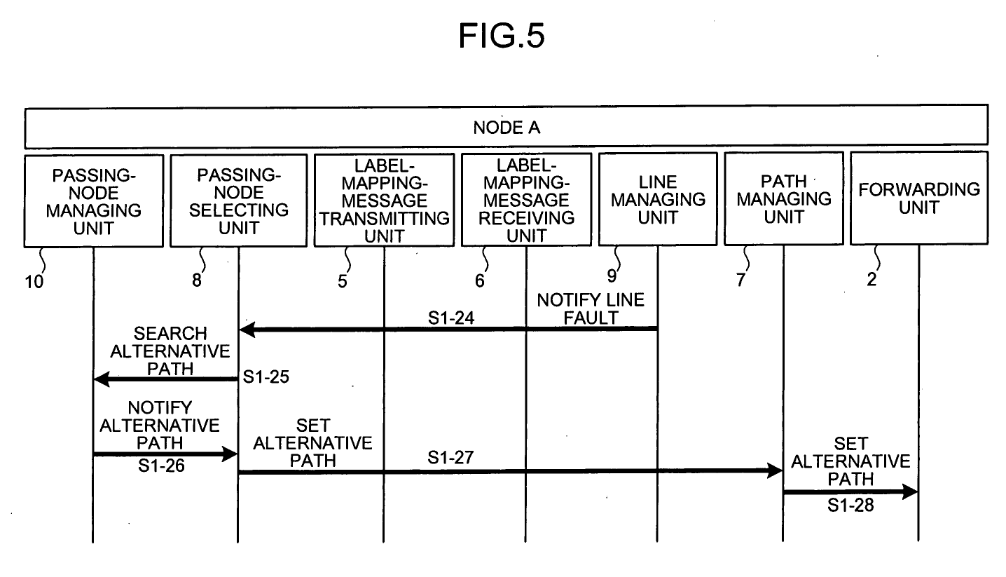

With reference to FIGS. 4 and 5, a description is given of a sequence of setting an alternative path upon occurrence of a line fault between the nodes A and B with the optimal path set as shown in FIGS. 2 and 3, and Table 3. FIG. 4 depicts a flow of data, and FIG. 5 depicts the sequence.

When detecting a line fault (1. in FIG. 4), the line managing unit 9 of the node A notifies the passing-node selecting unit 8 of the node A of fault-occurred line information (step S1-24). Upon reception of the notification of the line fault, the passing-node selecting unit 8 of the node A requests the passing-node managing unit 10 of the node A to search for an alternative path (step S1-25). Upon reception of the alternative path search request, the passing-node managing unit 10 of the node A checks label information for alternative paths (see Table 3), registered at the time of setting the path, in the order of registration.

Since the PV TLV information “D, A, B, C” received from the node D includes the router identifier “A” of the node A, the use of the label information allows for detection of the occurrence of the loop from the node A, to the node D, and back to the node A (2. and 3. in FIG. 4). Accordingly, the passing-node managing unit 10 of the node A considers the label information from the node D as inadequate for an alternative path, and changes the status of the information from the node D from “unused” (see Table 3) to “loop” as shown in Table 4.

TABLE 4

| | Label-mapping | | |
|---|---|---|---|
| | message | Label | Path-vector TLV |
| Status | transmission source | information | information |
| Fault | Node B | b | B, C |
| Loop | Node D | d | D, A, B, C |
| Used | Node F | f | F, G, C |

Since the PV TLV information “F, G, C” received from the node F does not include the router identifier “A” of the node A, the use of the label information makes it understood that packets can be relayed in a path from the node A to the node C, passing through the nodes F and G. Accordingly, the passing-node managing unit 10 of the node A determines the label information from the node F as an optimal path (3. in FIG. 4), and changes the status of the information from the node F from “unused” (see Table 3) to “used” as shown in Table 4. The status of the information from the node B is changed from “used” (see Table 3) to “fault”.

The passing-node managing unit 10 of the node A then notifies the passing-node selecting unit 8 of the node A of the alternative path (step S1-26). Upon reception of the notification of the alternative path, the passing-node selecting unit 8 of the node A requests the path managing unit 7 of the node A to set the alternative path (step S1-27). Upon reception of the request from the passing-node selecting unit 8, the path managing unit 7 of the node A sets the alternative path in the forwarding unit 2 (step S1-28).

Since increase in the time for line disconnection originated from a loop and increase in the amount of unnecessary traffic can be avoided by preventing the occurrence of the loop state, it is possible to instantaneously switch the path and shorten the time for traffic disconnection. This makes it possible to reduce the network load and packet losses in the transient state when fault-originated bypassing takes place.

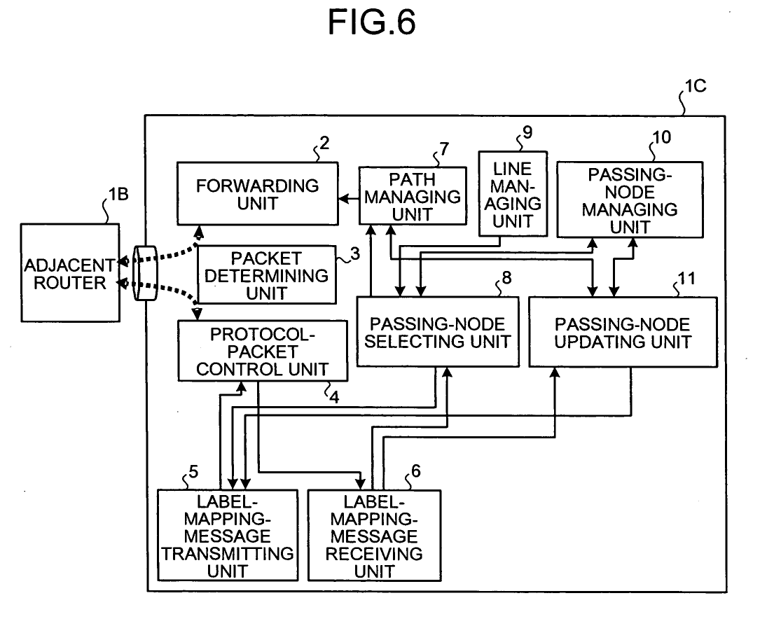

FIG. 6 is a schematic of a router that realizes an optimal path selection system according to a second embodiment of the present invention. In the second embodiment, as shown in FIG. 6, the router 1C as a node includes a passing-node updating unit 11 that matches an alternative path with a priority path determined by the routing protocol, in addition to the structure of the first embodiment. The passing-node updating unit 11 notifies the passing-node managing unit 10 of label information and PV TLV information, which are notified by the label-mapping-message receiving unit 6.

When the passing-node updating unit 11 is notified of the priority path determined by the routing protocol by the path managing unit 7, it refers to information registered in the passing-node managing unit 10. Upon reception of an alternative path from the passing-node managing unit 10, the passing-node updating unit 11 causes the path managing unit 7 to set the alternative path. The passing-node updating unit 11 notifies the label-mapping-message transmitting unit 5 of updated label information and PV TLV information.

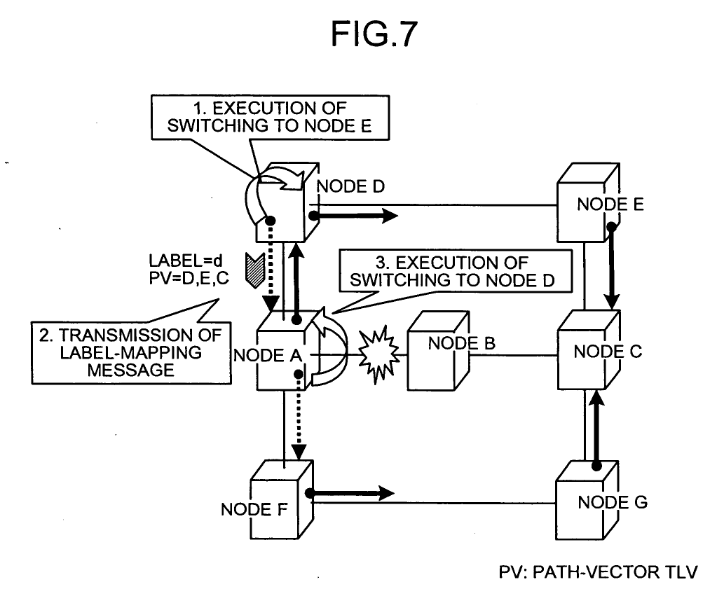

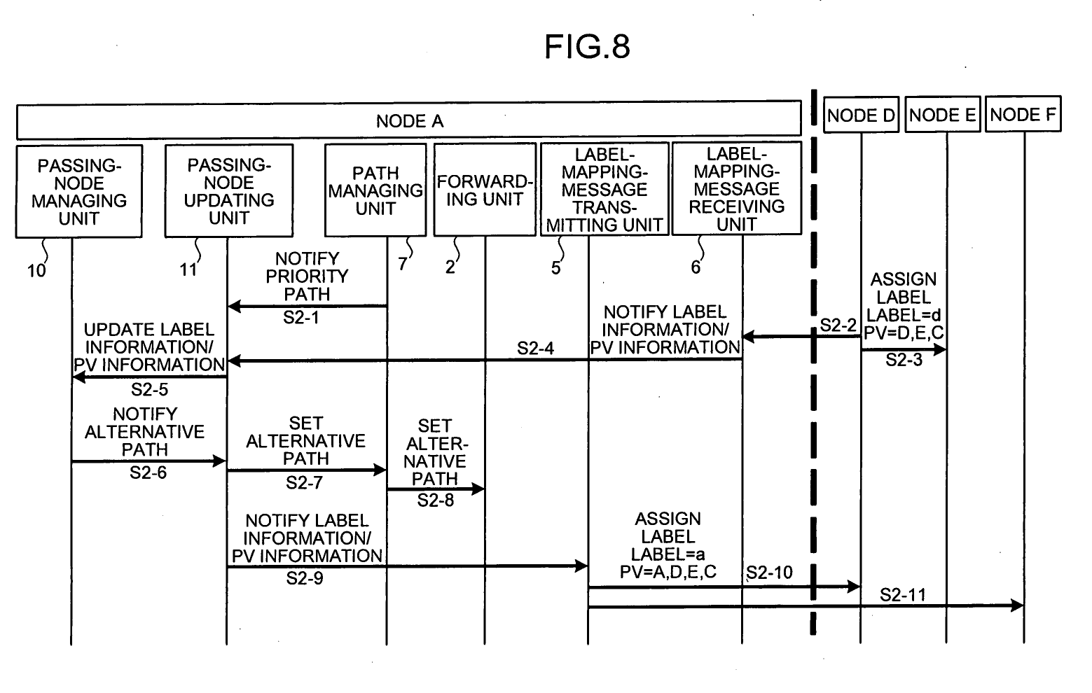

With reference to FIGS. 7 and 8, a description is given of a sequence when an alternative path selected according to the sequence of the first embodiment differs from a priority path determined by the routing protocol due to occurrence of a line fault between the node A and the node B. FIG. 2 depicts a flow of data, and FIG. 3 depicts the sequence. It is assumed that an alternative path going through the node F and the node G is set by the first embodiment as shown in FIGS. 4 and 5, and Table 4. It is also assumed that the priority path determined by the routing protocol is the node D. Each of the seven nodes A to G includes the router 1C shown in FIG. 6.

The path managing unit 7 of the node A notifies the passing-node updating unit 11 of the node A of the priority path (node D) determined by the routing protocol (step S2-1). Upon reception of the notification of the priority path, the passing-node updating unit 11 of the node A refers to PV TLV information “D, A, B, C” (see Table 4), registered in the passing-node managing unit 10 of the node A and received from the node D. As the router identifier “A” of the node A is included in the referred PV TLV information “D, A, B, C”, the passing-node updating unit 11 of the node A changes the status of the information from the node D from “loop” (see Table 4) to “priority path and loop” as shown in Table 5.

TABLE 5

| | Label-mapping | | |
|---|---|---|---|
| | message | | Path-vector |
| | transmission | Label | TLV |
| Status | source | information | information |
| Fault | Node B | b | B, C |
| Priority | Node D | d | D, A, B, C |
| path and | | | |
| loop | | | |
| Used | Node F | f | F, G, C |

When the priority path is changed to the node E under the situation (1. in FIG. 7), the node D transmits a label-mapping message containing label information “d” of the node and PV TLV information “D, E, C” to all the adjacent nodes, namely the node A, and the node E (steps S2-2 and S2-3, and 2. in FIG. 7). The label-mapping-message receiving unit 6 of the node A receives the label-mapping message transmitted from the node D, and notifies the passing-node updating unit 11 of the node A of the label information “d” and PV TLV information “D, E, C” in the label-mapping message (step S2-4). Upon reception of the notification, the passing-node updating unit 11 of the node A requests the passing-node managing unit 10 of the node A to update the label information and the PV TLV information (step S2-5).

Upon reception of the request to update the label information and the PV TLV information, the passing-node managing unit 10 of the node A checks that new PV TLV information does not include the router identifier “A” of the node, and determines the new label information as a new optimal path. The passing-node managing unit 10 of the node A then changes the PV TLV information from the node D from “D, A, B, C” (see Table 5) to “D, E, C”, changes the status of the information from the node D from “priority path and loop” (see Table 5) to “used” (3. in FIG. 7), and changes the status of the information from the node F from “used” (see Table 5) to “unused”, and then notifies the passing-node updating unit 11 of the node A of the new alternative path (step S2-6).

TABLE 6

| | Label-mapping | | |
|---|---|---|---|
| | message | Label | Path-vector TLV |
| Status | transmission source | information | information |
| Fault | Node B | b | B, C |
| Used | Node D | d | D, E, C |
| Unused | Node F | f | F, G, C |

Upon reception of the notification of the new alternative path, the passing-node updating unit 11 of the node A requests the path managing unit 7 of the node A to set the alternative path (step S2-7). Upon reception of the alternative path setting request, the path managing unit 7 of the node A sets the alternative path in the forwarding unit 2 of the node A (step S2-8). Upon reception of the notification of the new alternative path, the passing-node updating unit 11 of the node A notifies the label-mapping-message transmitting unit 5 of the label information and PV TLV information for the alternative path (step S2-9).

Upon reception of the notification, the label-mapping-message transmitting unit 5 of the node A transmits a label-mapping message containing the label information “a” of the node and the PV TLV information “A, D, E, C” to all the adjacent nodes, namely the node D and the node F (step S2-10 and S2-11). The optimal path can be matched with the priority path on the routing protocol in this manner after a loop state is canceled.

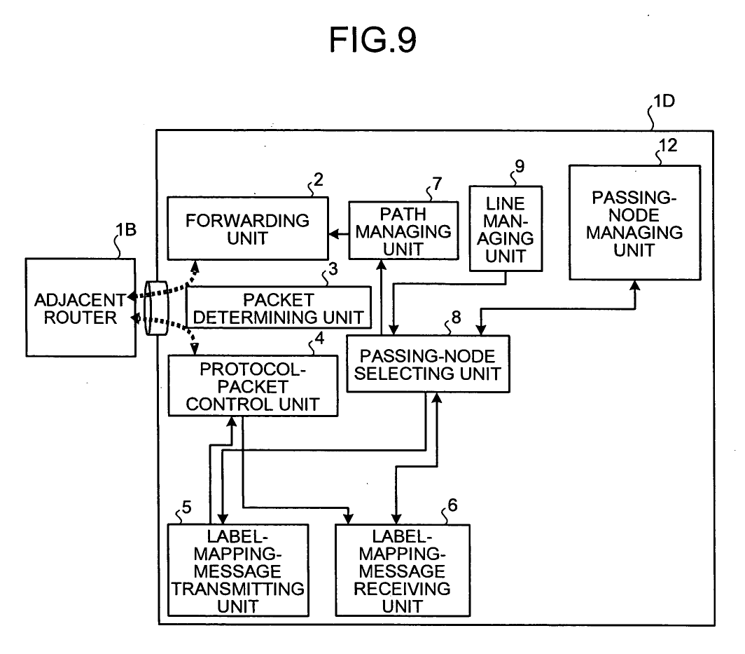

FIG. 9 is a schematic of a router that realizes an optimal path selection system according to a third embodiment of the present invention. In the third embodiment, as shown in FIG. 9, a router 1D as a node has a passing-node managing unit 12. The passing-node managing unit 12 manages label information and PV TLV information, notified by the passing-node selecting unit 8, in an ascending order in the number of nodes on a path in the PV TLV information. In response to a request to search for an alternative path, the passing-node managing unit 12 searches for an optimal path, and notifies the request source of the search result.

A description is given of a sequence of setting an optimal path for the IP network before occurrence of a line fault, and a sequence of setting an alternative path originating from occurrence of a line fault. Each of the seven nodes A to G includes the router 1D shown in FIG. 9.

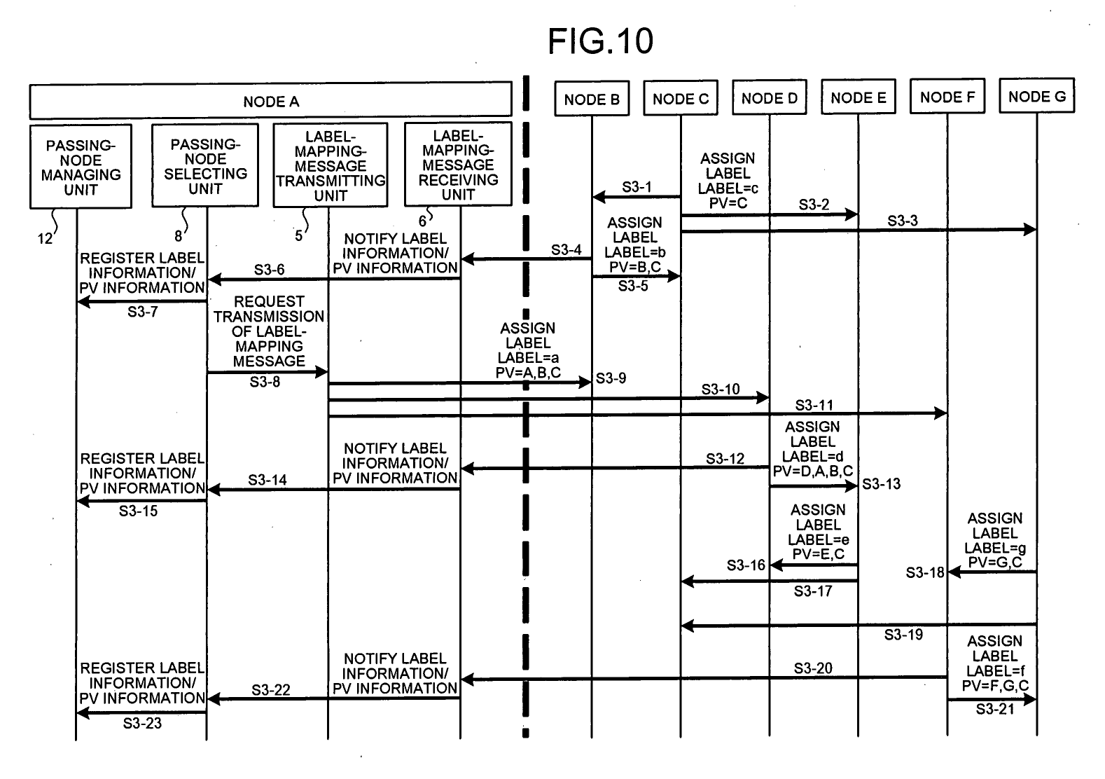

FIG. 10 depicts a sequence of setting an optimal path for the IP network before occurrence of a line fault. The sequence is the sequence in FIG. 3 in which the passing-node managing unit 10 is replaced with the passing-node managing unit 12. Accordingly, the sequence of the third embodiment is easily understood by reading the “passing-node managing unit 10“in the description of the sequence in FIG. 3 according to the first embodiment as the passing-node managing unit 12, and “step S1-x” (x being any one of 1 to 23) as step S3-x, so that the detailed description therefor is omitted.

However, it should be noted that if the label information “f” and PV TLV information “F, G, C” received from the node F are registered in the passing-node managing unit 12 of the node A at step S3-23, those pieces of information are registered in the passing-node managing unit 12 in the node-number ascending order in the PV TLV information, as shown in Table 7. As there are two nodes, three nodes, and four nodes to be passed in the PV TLV information of the node B, the node F and the node D, respectively, the label information “f” and PV TLV information “F, G, C” are managed in the order of the node B, the node F, and the node D.

TABLE 7

| | Label-mapping | | |
|---|---|---|---|
| | message | Label | Path-vector TLV |
| Status | transmission source | information | information |
| Used | Node B | b | B, C |
| Unused | Node D | f | F, G, C |
| Unused | Node F | d | D, A, B, C |

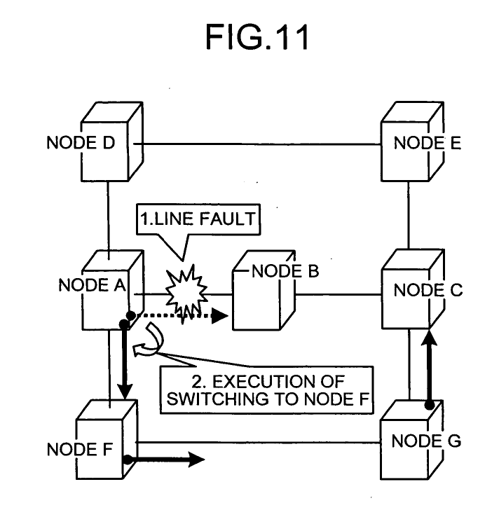

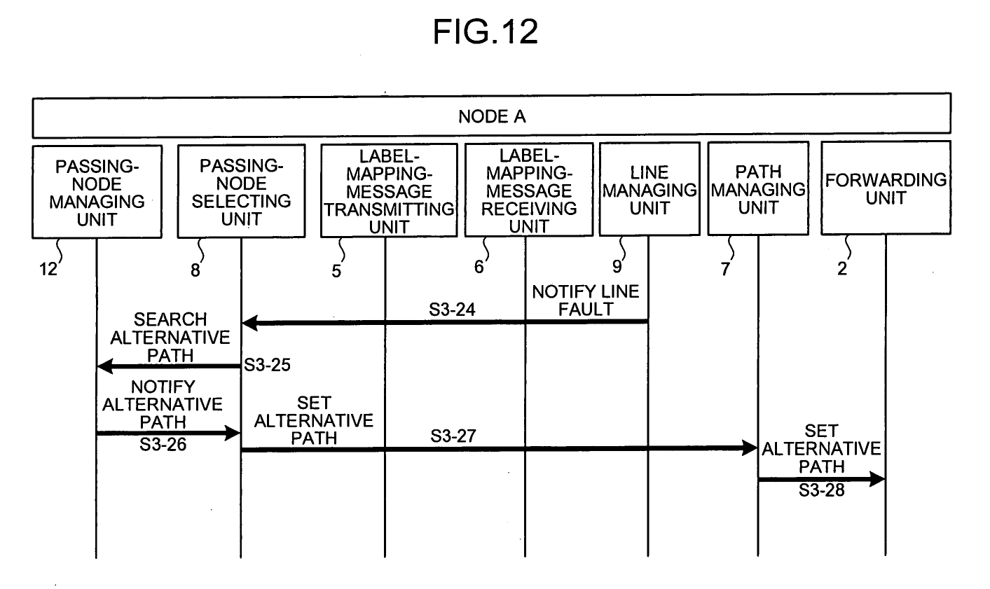

With reference to FIGS. 11 and 12, a description is given of a sequence of setting an alternative path upon occurrence of a line fault similar to the one in the first embodiment in the situation. FIG. 11 depicts a flow of data, and FIG. 12 depicts the sequence.

When detecting a line fault (1. in FIG. 11), the line managing unit 9 of the node A notifies the passing-node selecting unit 8 of the node A of fault-occurred line information (step S3-24). Upon reception of the notification of the line fault, the passing-node selecting unit 8 of the node A requests the passing-node managing unit 12 of the node A to search for an alternative path (step S3-25). Upon reception of the alternative path search request, the passing-node managing unit 12 of the node A checks label information for alternative paths (see Table 7) in the node-number ascending order in the PV TLV information.

As the PV TLV information “F, G, C” received from the node F that has the second fewest nodes to the node B does not include the router identifier “A” of the node A, the use of the label information makes it understood that packets can be relayed in a path from the node A to the node C, passing through the nodes F and G. Accordingly, the passing-node managing unit 12 of the node A determines the label information from the node F as an optimal path (2. in FIG. 11), and changes the status of the information from the node F from “unused” (see Table 7) to “used” as shown in Table 8. The status of the information from the node B is changed from “used” (see Table 7) to “fault”.

TABLE 8

| | Label-mapping | | |
|---|---|---|---|
| | message | Label | Path-vector TLV |
| Status | transmission source | information | information |
| Fault | Node B | b | B, C |
| Used | Node D | f | F, G, C |
| Unused | Node F | d | D, A, B, C |

The passing-node managing unit 12 of the node A then notifies the passing-node selecting unit 8 of the node A of the alternative path (step S3-26). Upon reception of the notification of the alternative path, the passing-node selecting unit 8 of the node A requests the path managing unit 7 of the node A to set the alternative path (step S3-27). Upon reception of the request from the passing-node selecting unit 8, the path managing unit 7 of the node A sets the alternative path in the forwarding unit 2 (step S3-28).

As path switching can be performed spontaneously without checking looping paths in the above-described manner, the traffic disconnection time can be made shorter. When the optimal path determined does not match with a priority path determined later by the routing protocol, a path switching operation should be performed again like the second embodiment. According to the third embodiment, however, the possibility that both paths coincide with each other by selecting an alternative path in the node-number ascending order, thus making it possible to avoid re-execution of the path switching operation. The router can have the passing-node updating unit 11 like the second embodiment, so that after a loop state is released, the optimal path matches with a priority path on the routing protocol.

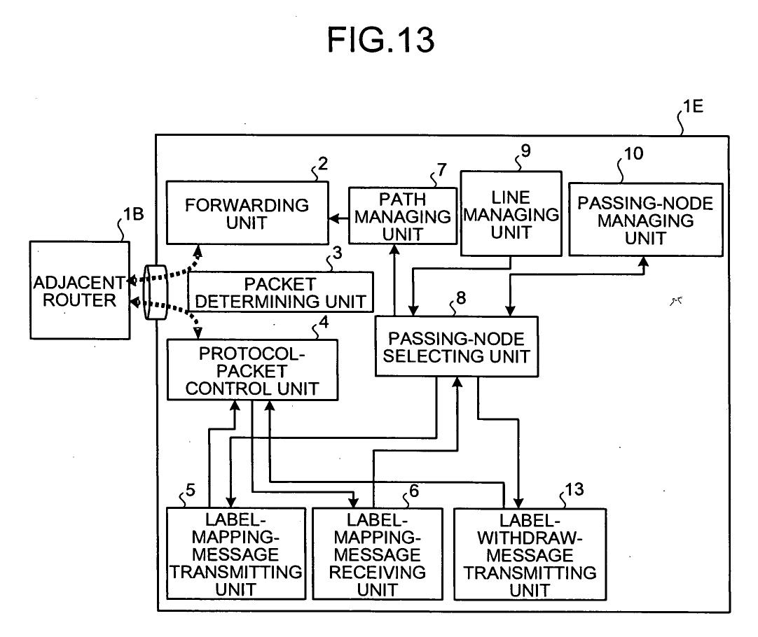

FIG. 13 is a schematic of a router that realizes an optimal path selection system according to a fourth embodiment of the present invention. In the fourth embodiment, as shown in FIG. 13, a router 1E as a node includes a label-withdraw-message transmitting unit 13 in addition to the structure of the first embodiment. In response to a request from the passing-node selecting unit 8, the label-withdraw-message transmitting unit 13 adds the identifier of the node to PV TLV information as a specific TLV, and transmits a label-withdraw message to the adjacent node 1B.

A description is given of a sequence of setting an optimal path for the IP network before occurrence of a line fault, and a sequence of setting an alternative path originating from occurrence of a line fault. Each of the seven nodes A to G includes the router 1E shown in FIG. 13.

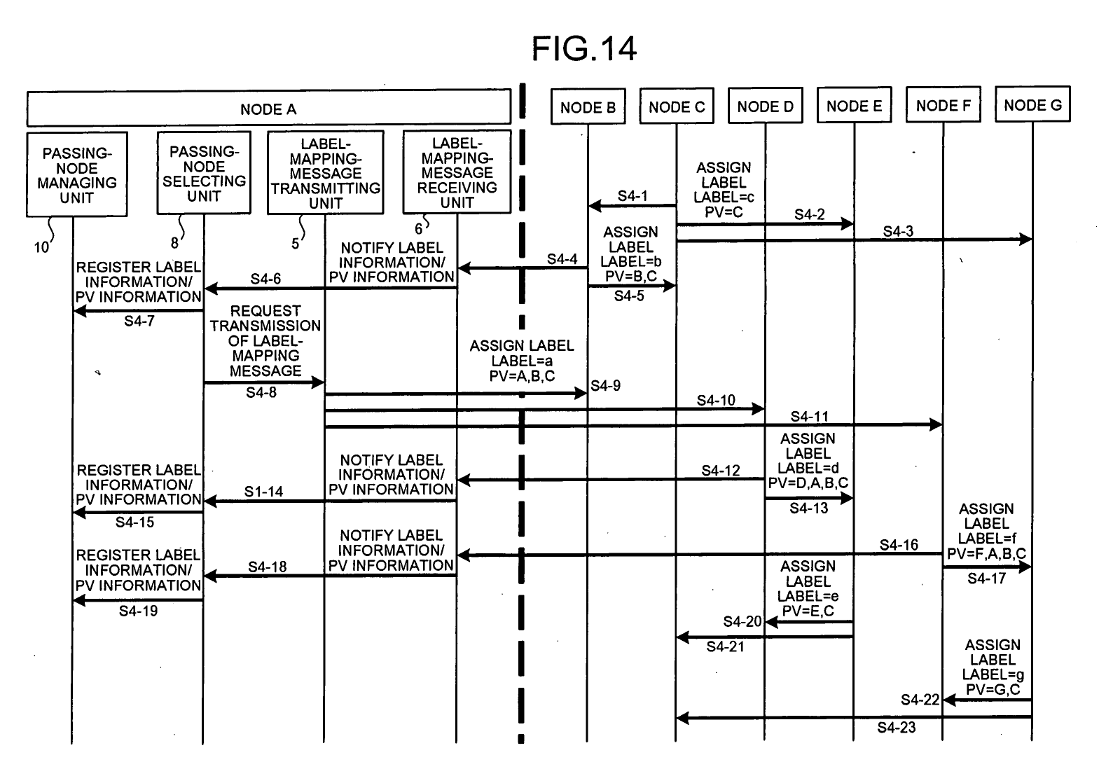

FIG. 14 depicts a sequence of setting an optimal path for the IP network before occurrence of a line fault. Steps S4-1 to S4-15 are the same as steps S1-1 to S1-15 in the sequence in FIG. 3. Accordingly, the sequence of the fourth embodiment is easily understood by reading the steps S1-y (y being any one of 1 to 15) as step S4-y in the explanation of steps S1-1 to S1-15, so that the detailed description therefor is omitted. The following description starts with step S4-16.

The node F that has received the label-withdraw-message transmitting unit 13 at step S4-11 adds the router identifier “F” of the node F to the received PV TLV information “A, B, C”, and transmits a label-mapping message containing the label information “f” of the node and the PV TLV information “F, A, B, C” to all the adjacent nodes, namely the node A and the node G (steps S4-16 and S4-17).

The node A that has received the label-mapping message from the node F registers the received label information “f” and PV TLV information “F, A, B, C” in the passing-node managing unit 10 of the node A through an operation similar to the operation at steps S4-6 and S4-7 (steps S4-18 and S4-19). At this time, the received label information “f”, the PV TLV information “F, A, B, C”, and the status of the information from the node F being “unused” are added to the information (see Table 2) registered in the passing-node managing unit 10 of the node A at steps S4-7 and S4-15.

TABLE 9

| | Label-mapping | | |
|---|---|---|---|
| | message | Label | Path-vector TLV |
| Status | transmission source | information | information |
| Used | Node B | d | B, C |
| Unused | Node D | b | D, A, B, C |
| Unused | Node F | f | F, A, B, C |

The node E and the node G receive the label-mapping message transmitted from the node C at step S4-2 and step S4-3. The node E performs an operation similar to the one done at steps S1-16 and S1-17 (steps S4-20 and S4-21). The node G performs an operation similar to the one done at steps S1-18 and S1-19 (steps S4-22 and S4-23).

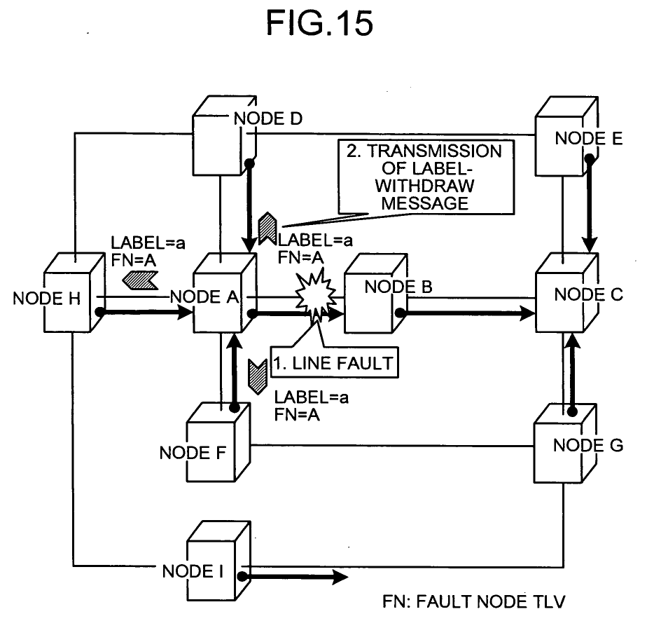

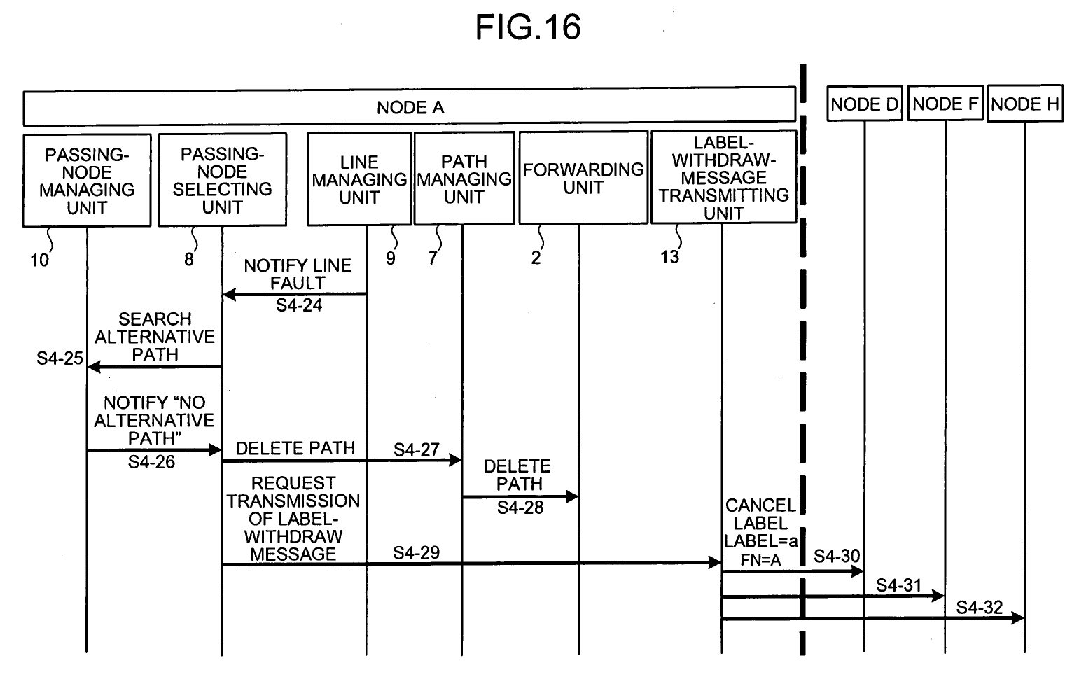

With reference to FIGS. 15 and 16, a description is given of a sequence of setting an alternative path upon occurrence of a line fault similar to the one in the first embodiment in the situation. FIG. 15 depicts a flow of data, and FIG. 16 depicts the sequence. As shown in FIG. 15, a node H, which is connected to the nodes A and D and whose optimal path is directed toward the node A, and a node I, which is connected to the nodes G and H and whose optimal path is directed toward the node G, are added to the IP network. Each of the nodes H and I include the router 1E shown in FIG. 13.

When detecting a line fault (1. in FIG. 15), the line managing unit 9 of the node A performs an operation similar to the one done at steps S4-24 and S4-25 (steps S4-24 and S4-25). Upon reception of the alternative path search request, the passing-node managing unit 10 of the node A checks label information for alternative paths (see Table 9) in the order of registration.

The registered information from the node D is referred first. As the received PV TLV information “D, A, B, C” includes the router identifier “A” of the node A, the passing-node managing unit 10 of the node A considers the label information from the node D as inadequate for an alternative path, and changes the status of the information from the node D from “unused” (see Table 9) to “loop” as shown in Table 10.

TABLE 10

| | Label-mapping | | |
|---|---|---|---|
| | message | Label | Path-vector TLV |
| Status | transmission source | information | information |
| Fault | Node B | b | B, C |
| Loop | Node D | d | D, A, B, C |
| Loop | Node F | f | F, A, B, C |

As the PV TLV information “F, A, B, C” received from the node F includes the router identifier “A” of the node A, the use of the label information makes it understood that there occurs a loop starting from the node A, passing through the node F, then returning to the node A. Accordingly, the passing-node managing unit 10 of the node A considers the label information from the node F as an inadequate alternative path, and changes the status of the information from the node F from “unused” (see Table 9) to “loop” as shown in Table 10. The status of the information from the node B is changed from “used” (see Table 9) to “fault”.

As there is no other label information for an alternative path, the passing-node managing unit 10 of the node A understands that the node cannot perform the bypass operation, and notifies the passing-node selecting unit 8 of no alternative path being available (step S4-26). Upon reception of the notification of no alternative path available, the passing-node selecting unit 8 of the node A requests the path managing unit 7 of the node A to delete the alternative path (step S4-27). Upon reception of the request from the passing-node selecting unit 8, the path managing unit 7 of the node A deletes the alternative path from the forwarding unit 2 (step S4-28).

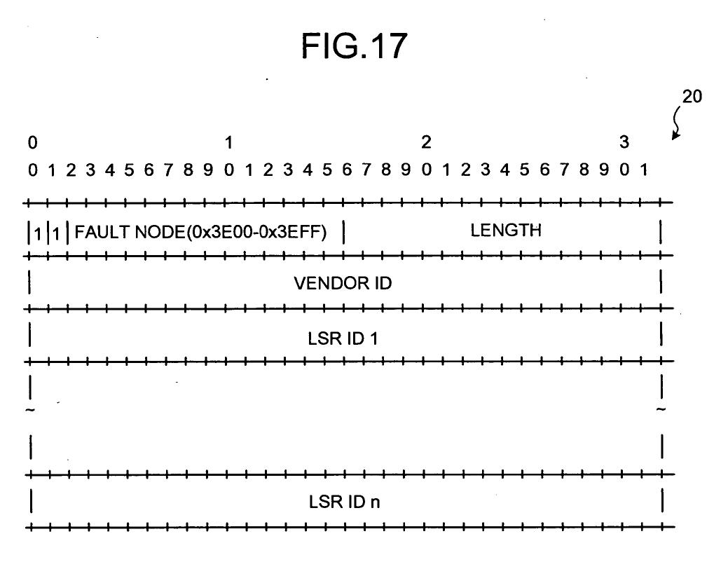

Upon reception of the notification of no alternative path available, the passing-node selecting unit 8 of the node A requests the label-withdraw-message transmitting unit 13 of the node A to transmit a label-withdraw message (step S4-29). Upon reception of the label-withdraw message transmitting request, the label-withdraw-message transmitting unit 13 of the node A sets the router identifier “A” of the node A to fault node (FN) TLV information as a specific TLV, and transmits a label-withdraw message including the label information “a” of the node and the PV TLV information “A” to all the adjacent nodes, namely, the node D, the node F and the node H (steps S4-30, S4-31 and S4-32, and 2. in FIG. 15). FIG. 17 depicts a data format 20 of specific TLV information.

Through the operation, a node can notify an adjacent node that the node cannot perform a bypass operation when there is no alternative path that does not cause a loop state. Therefore, the node can prompt the adjacent node to select an alternative path that does not pass through the node. Because the fourth embodiment is designed to transmit a label-withdraw message to an adjacent node when the node cannot perform a bypass operation, each of the nodes D, F and H includes the router 1E of the node shown in FIG. 13. To effectively use the label-withdraw message transmitted from the node A, each of the nodes D, F and H should include a unit that receives the label-withdraw message (label-withdraw message receiver 14 in a fifth embodiment of the present invention).

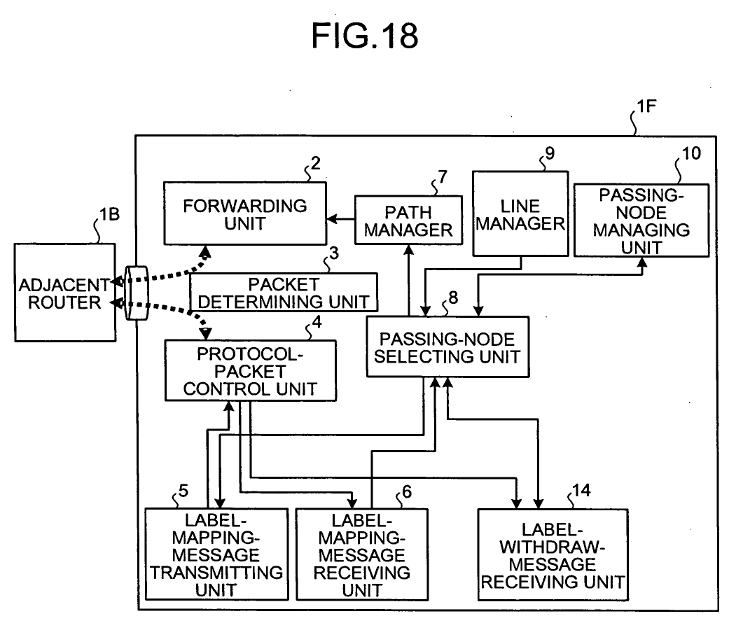

FIG. 18 is a schematic of a router that realizes an optimal path selection system according to the fifth embodiment. In the fifth embodiment, as shown in FIG. 18, a router 1F as a node includes a label-withdraw message receiver 14 in addition to the structure of the first embodiment. The label-withdraw message receiver 14 receives a label-withdraw message from an adjacent node, and extracts label information and PV TLV information, as a specific TLV, from the label-withdraw message. The label-withdraw message receiver 14 then notifies the passing-node selecting unit 8 of the label information and the PV TLV information.

A description is given of a sequence of setting an optimal path for the IP network before occurrence of a line fault, and a sequence of setting an alternative path originating from occurrence of a line fault. The fifth embodiment is associated with an operation that takes place after the node A transmits the label-withdraw message in the fourth embodiment. Accordingly, the IP network takes the structure shown in FIG. 15, the node A includes the router 1E having the structure shown in FIG. 13, and each of the nodes D, F, and H includes the router 1F having the structure shown in FIG. 18.

In setting an optimal path of the IP network before occurrence of a line fault, the node H receives a label-mapping message including label information “a” and PV TLV information “A, B., C” from the node A, receives a label-mapping message including label information “d” and PV TLV information “D, A, B, C” from the node D, and receives a label-mapping message including label information “i” and PV TLV information “I, G, C” from the node I. Information from the node A, information from the node D, and information from the node I are then registered in the passing-node managing unit 10 of the node H in the order of reception as shown in Table 11. It is assumed that the status of the information from the node A is set to “used”, and the statuses of the information from the nodes D and I are set to “unused”.

TABLE 11

| | | | Path-vector |
|---|---|---|---|
| | Label-mapping message | Label | TLV |
| Status | transmission source | information | information |
| Used | Node A | a | A, B, C |
| Unused | Node D | d | D, A, B, C |
| Unused | Node I | i | I, G, C |

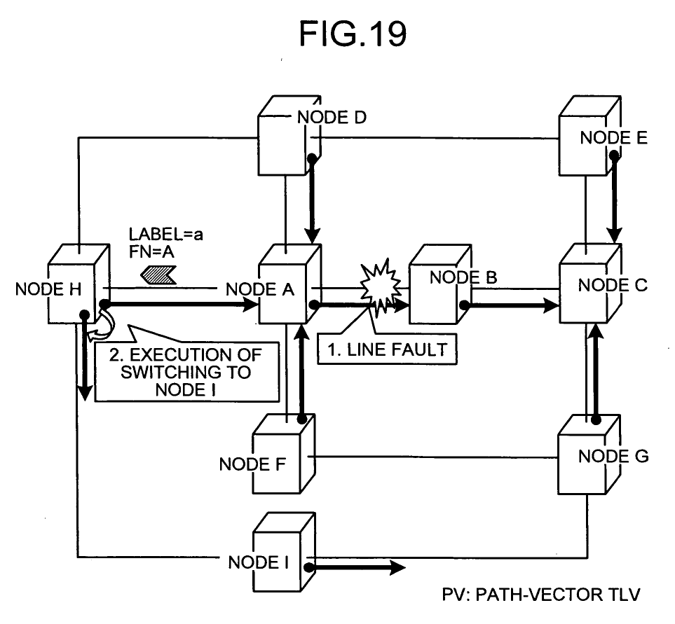

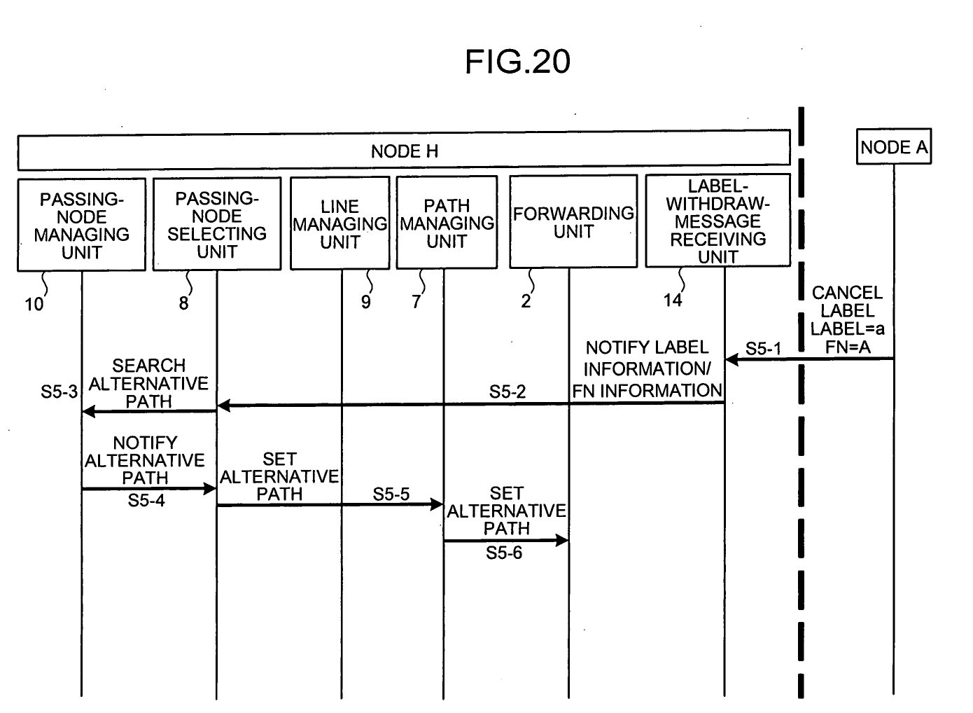

An operation following step S4-32 in the fourth embodiment in the sequence of setting an alternative path upon occurrence of a line fault is described with reference to FIGS. 19 and 20. FIG. 19 depicts a flow of data, and FIG. 20 depicts the sequence. The label-withdraw message receiver 14 of the node H receives a label-withdraw message transmitted from the node A (step S5-1), and notifies the passing-node selecting unit 8 of the node H of the label information “a” and the PV TLV information “A” in the label-withdraw message (step S5-2).

Upon reception of the notification of a line fault, the passing-node selecting unit 8 of the node H requests the passing-node managing unit 10 of the node H to search for an alternative path (step S5-3). Upon reception of the alternative path search request, the passing-node managing unit 10 of the node H checks label information (see Table 11) for alternative paths registered at the time of setting paths in the order of registration, and retrieves label information having PV TLV information that does not include the router identifier “A” in the PV TLV information.

As the PV TLV information “D, A, B, C” received from the node D includes the router identifier “A” of the node A, the use of the label information makes it understood that packets are discarded at the node A. Accordingly, the passing-node managing unit 10 of the node H considers the label information from the node D as an inadequate alternative path, and changes the status of the information from the node D from “unused” (see Table 11) to “disabled traffic” as shown in Table 12.

TABLE 12

| | Label-mapping | | |
|---|---|---|---|
| | message | | Path-vector |
| | transmission | Label | TLV |
| Status | source | information | information |
| Disabled | Node A | a | A, B, C |
| traffic | | | |
| Disabled | Node D | d | D, A, B, C |
| traffic | | | |
| Used | Node I | i | I, G, C |

As the PV TLV information “I, G, C” received from the node I does not include the router identifier “A” of the node A, the use of the label information makes it understood that packets can be relayed in a path from the node H to the node C, passing through the nodes I and G. Accordingly, the passing-node managing unit 10 of the node H determines the label information from the node I as an optimal path (2. in FIG. 19), and changes the status of the information from the node I from “unused” (see Table 11) to “used” as shown in Table 12. The status of the information from the node A is changed from “used” (see Table 11) to “disabled traffic”.

The passing-node managing unit 10 of the node H then notifies the passing-node selecting unit 8 of the node H of the alternative path (step S5-4). Upon reception of the notification of the alternative path, the passing-node selecting unit 8 of the node H requests the path managing unit 7 of the-node H to set the alternative path (step S5-5). Upon reception of the request from the passing-node selecting unit 8, the path managing unit 7 of the node H sets the alternative path in the forwarding unit 2 (step S5-6). Through the operation, even when the node does not detect a line fault, it is possible to adequately select an alternative path that prevents packets from being discarded at any relay node on the way, thus shortening the traffic disconnection time.

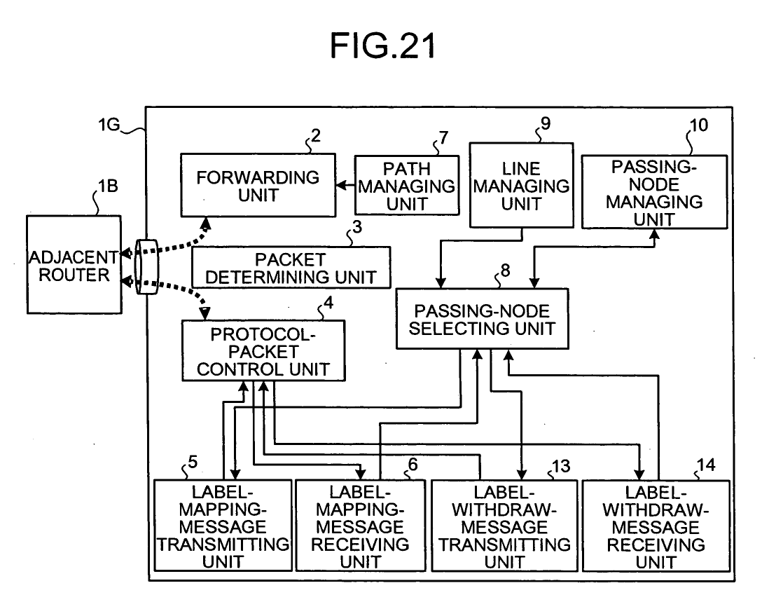

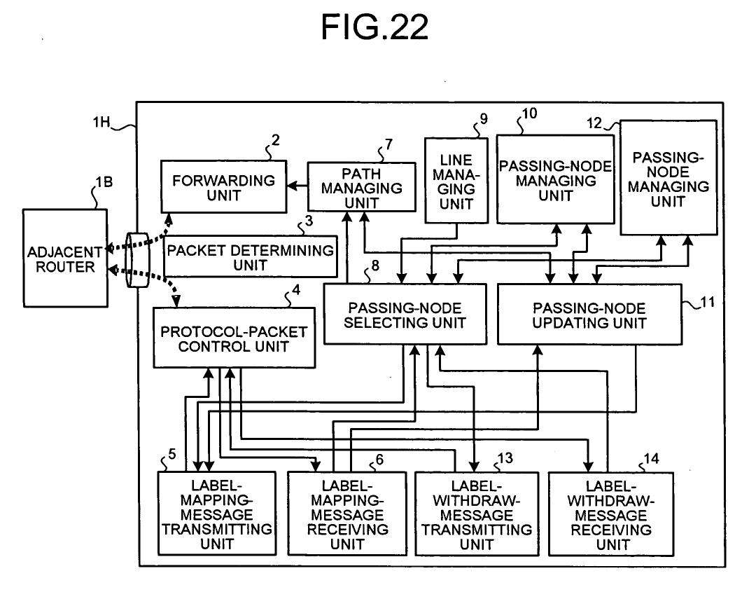

The present invention is not limited to the above embodiments, and various modifications can be made. For example, in the fourth and the fifth embodiments, a router 1G that is the router 1A in FIG. 1 to which the label-withdraw-message transmitting unit 13 and the label-withdraw message receiver 14 are added can be used, as shown in FIG. 21. In each embodiment, a router 1H that is the router 1A in FIG. 1 to which the passing-node updating unit 11, the passing-node managing unit 12, the label-withdraw-message transmitting unit 13 and the label-withdraw message receiver 14 are added can be used, as shown in FIG. 22, so that the passing-node managing unit 10 or the passing-node managing unit 12 can be selectively used according to a request from a client.

According to the embodiments described above, it is possible to quickly switch paths in an LDP. Moreover, it is possible to select an alternative path not causing a loop. Furthermore, it is possible to reduce a network load and packet losses.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

What is claimed is:

1. A system for selecting an optimal path in a network using a plurality of routers that perform data transfer based on a label affixed to a packet, the system comprising
a router including
a receiving unit configured to receive a label-mapping message that includes information on a path, from at least one adjacent router;
a registering unit configured to register the information; and
a selecting unit configured to select, from among paths included in registered information, a path that does not include the router, to select an optimal path, wherein
the optimal path is a path that does not cause a loop.

2. The system according to claim 1, wherein the router further includes a transmitting unit configured to transmit, to an adjacent router, information on a path by including the information in the label-mapping message, the information created by adding the router to the path up to the router.

3. The system according to claim 1, wherein the router further includes a transmitting unit configured to transmit, to an adjacent node, information on a path that includes the router as a first router, by including the information in the label-mapping message.

4. The system according to claim 1, wherein the information on a path includes a path-vector type length value defined in the request for comments (RFC) 3036.

5. The system according to claim 1, wherein
the router further includes a switching unit configured to switch a path to a priority path determined based on a routing protocol, and
when the optimal path and the priority path do not match, the optimal path is used until the receiving unit receives a label-mapping message including information on a path that does not include the router from an adjacent router located on the priority path, and the switching unit is configured to switch the path from the optimal path to the priority path when the receiving unit receives the label-mapping message including the information on the path that does not include the router.

6. The system according to claim 1, wherein the selecting unit is configured to select the optimal path while checking the information in an order of reception of the label-mapping message.

7. The system according to claim 1, wherein the selecting unit is configured to select the optimal path while checking the information in an ascending order in number of routers on a path included in the information.

8. The system according to claim 1, wherein
the router further includes a transmitting unit configured to transmit, when there is no path that does not cause a loop, a label-withdraw message indicating that there is no optimal path available for the router, to the adjacent router.

9. The system according to claim 1, wherein
the router further includes a second receiving unit configured to receive, from an adjacent router, a label-withdraw message indicating that there is no optimal path for the adjacent router, and
the selecting unit is configured to select the optimal path by selecting a path that does not include the adjacent router having no optimal path, based on the label-withdraw message.
